(19) United States
(12) Patent Application Publication
(10) Pub. No.: US 2010/0005020 A1
(43) Pub. Date: Jan. 7, 2010

(54) FUNDING OF PROJECTS

(76) Inventor: Alexander Polinsky, Brookline, MA (US)

Correspondence Address: FISH & RICHARDSON PC, P.O. BOX 1022, MINNEAPOLIS, MN, 55440-1022, US

(21) Appl. No.: 12/167,291

(22) Filed: Jul. 3, 2008

(51) Int. Cl. G06Q 40/00

(52) U.S. Cl. 705/37

(57) ABSTRACT

Among other things, an online exchange facility is provided that runs software applications and exposes an online interface to users. The online interface enables a project entity to fund a project by online selling of securities that represent interests in the project to investors. The online interface also enables investors to trade the securities online at prices that are determined by market forces and are related to progress of the project in reaching a deliverable that has been defined for the project prior to the funding.

### BACKGROUND

This description relates to funding of projects.

Projects, such as projects to develop biotechnology or high technology products, are typically selected, managed, evaluated, and funded by the companies that will eventually market the products. Sometimes groups of such companies form and fund a research and development entity to perform one or more pieces of a project, for example, basic research that will produce information useful to the participating companies in their product work. In some instances, late stage biotechnology product development work has been funded as an individual project.

### SUMMARY

In general, in an aspect, an online exchange facility is provided that runs software applications and exposes an online interface to users. The online interface enables a project entity to fund a project by online selling of securities that represent interests in the project to investors. The online interface also enables investors to trade the securities online at prices that are determined by market forces and are related to progress of the project in reaching a deliverable that has been defined for the project prior to the funding.

Implementations may include one or more of the following features. The online interface also enables a project originator to list the project or the securities on the online exchange facility in accordance with listing rules. The deliverable is associated with potentially greater value of a product that depends on the reaching of the deliverable. The product comprises a drug. Listing the project depends on a determination whether the project meets quality criteria. The online interface enables the project entity to fund the project by conducting an online auction. The online interface is exposed through the World Wide Web. The online interface reports progress of a project against expected milestones and against progress of comparable projects. The online interface also provides investors online access to information that reports on progress of the project in reaching the deliverable. The online interface also enables experts to receive information about the project online and provide expert reports about the project online for use by investors. The online interface also enables parties engaged in executing the project to obtain and report progress in reaching the deliverable. The online interface also enables development of a valuation of the project based on information about progress in achieving the deliverable and on external market data. This information is provided online on a project dashboard. Successive projects or stages of projects are funded by distribution of successive rounds of securities that represent interests in the project. The securities have a call on intellectual property created by the project. The online interface also enables online trading of project securities.

These and other aspects and features, and combinations of them, can be expressed as apparatus, systems, methods, program products, methods of doing business, or means for performing functions, and in other ways.

Other advantages and features will become apparent from the following description and from the claims.

### DESCRIPTION

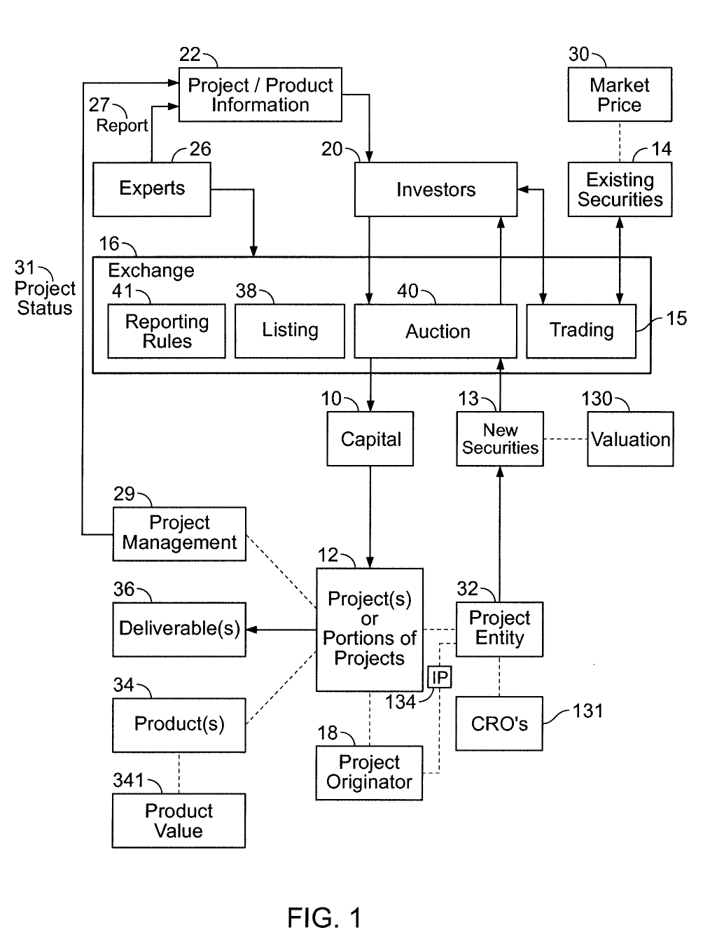

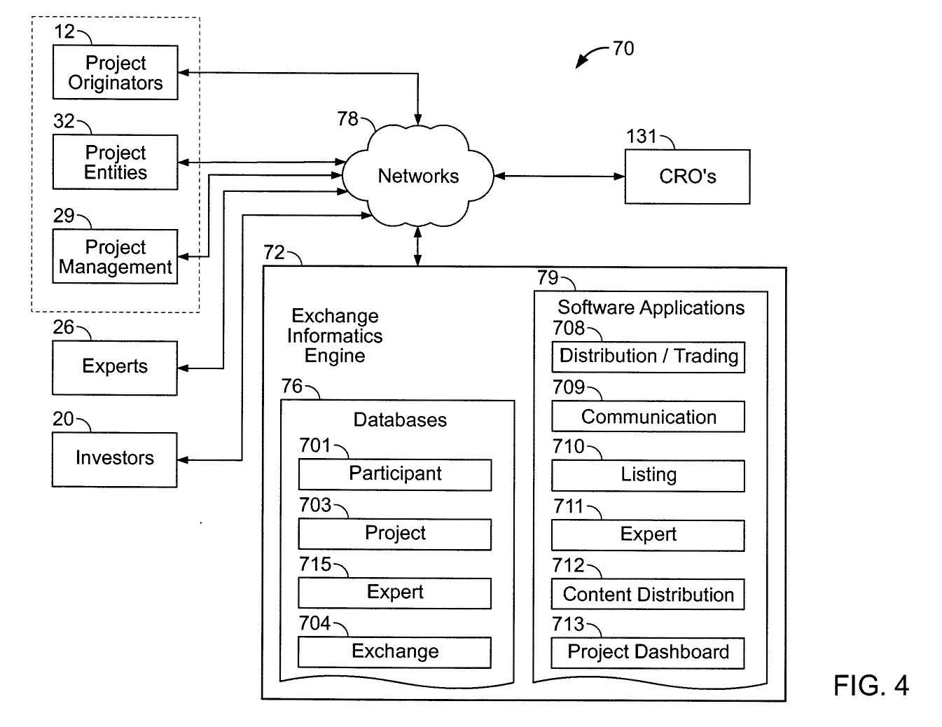

FIGS. 1 and 4 are block diagrams.

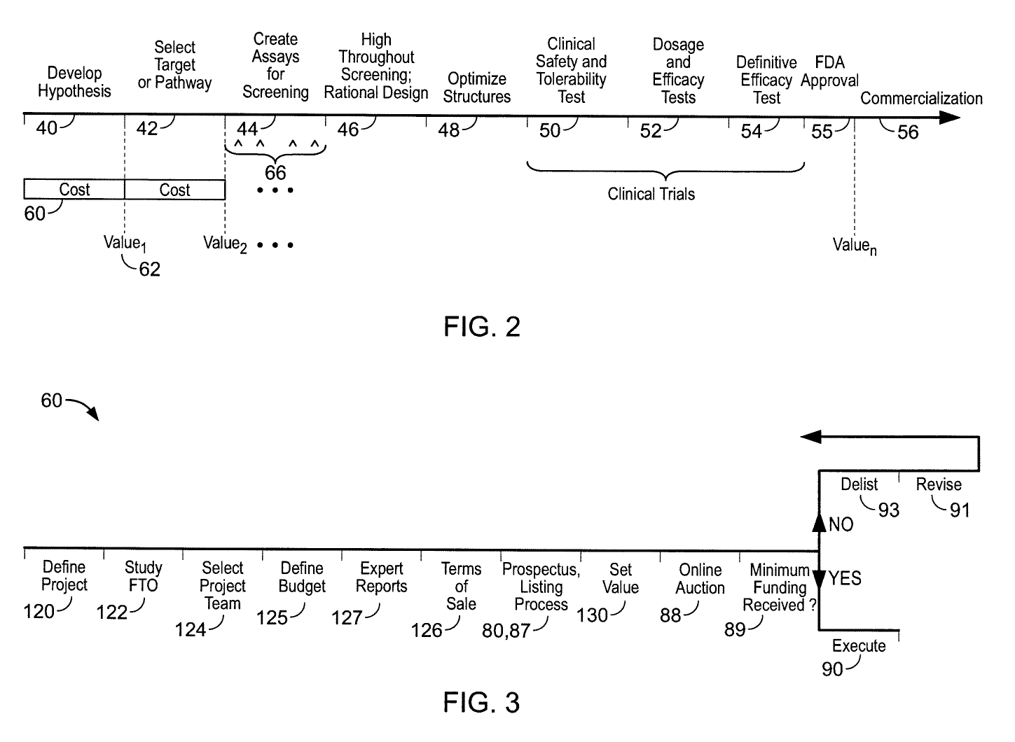

FIGS. 2 and 3 are time sequence charts.

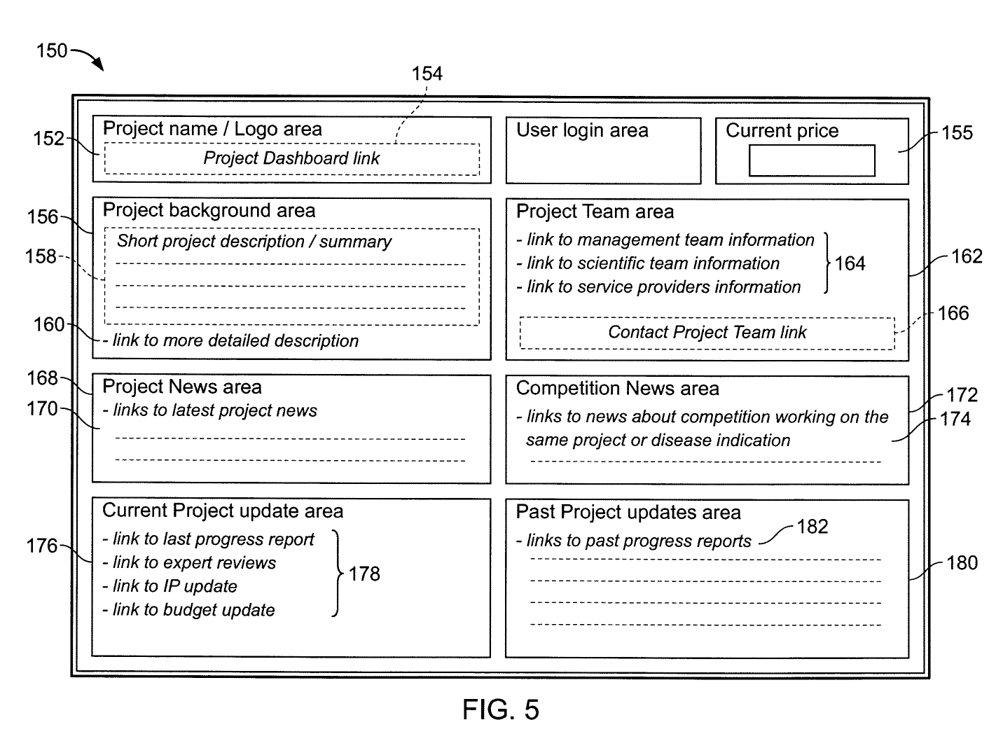

FIGS. 5 through 8 show user interface features.

In the following description, we often use examples that relate to projects for discovery and development of drug products (we sometimes call them DDD projects or simply projects). The features and aspects of the techniques described here are applicable to a broad range of projects not limited to DDD projects or drug products. When we use the term DDD project, or project, we mean to include, for example, all kinds of projects that have characteristics susceptible to the techniques that we describe, not merely drug discovery and development projects.

Projects can include, for example, any task or planned program of work that has one or more specific goals or targets or deliverables which have the possibility of enhancing the value of a product or a potential product. Products include, for example, any kind of tangible and intangible goods and services. A project may be comprehensive and extensive enough to span an entire development process from conception to commercialization of a product, or may encompass only part of the work needed to reach commercialization. We sometimes use the term product period to refer to the period beginning when the product is first being conceived and ending with the commercialization of the product. We sometimes use the term project period, similarly, to refer to the period beginning when the project is first conceived and ending when the project is completed or terminated.

Drug discovery projects are natural candidates for funding using facilities and techniques described here because both the kinds of milestones that must be passed in each stage of the project and the potential increases in product value after completing each milestone are well understood in the industry.

Each of the projects that is executed during the product period typically would be completed within one to three years and the entire product period could include six to eight or more projects over a product period that could run as long as twenty-five years or more. Some projects could be shorter or longer than one to three years, and the number of projects could be fewer than six or more than eight. The ultimate goal of a project may be, for example, to develop an FDA approved drug, an effort that can take more than a decade.

As shown in FIG. 1, capital 10 can be raised from investors 20 to fund one or more individual projects 12 or groups of them or portions or stages of them in exchange for newly issued securities 13 that represent value in or are otherwise associated with the projects, rather than (or in addition to) funding them from capital raised generally by a company that is also engaged in other activities not related to the funded project. We sometimes call the new securities or existing securities simply project securities. We also describe ways to enable trading 15 of existing securities 14 that represent value in or are otherwise associated with corresponding projects or stages (we sometimes use the term project to refer to a project or a stage of a project or a group of stages of a project). We sometimes refer to the period during which new securities are being distributed as the distribution period and to the period during which trading occurs as the trading period.

The issuance of such new securities and the trading of existing securities is facilitated by an exchange 16 that provides the following benefits, among others.

1. The projects can be financed (we sometimes use the term financing interchangeably with funding) by the exchange facility described here at any stage, including early discovery and technology development. A round of project securities could be offered at a number of different times, including the beginning of the project or the beginning of a given stage or stages of the project, typically upon the successful completion of (that is the successful completion of the deliverable of) a prior stage. A project or stage or stages of a project may include milestones during the project period. When a project is first listed on the exchange, or reaches a milestone, or runs out of funds, for example, the exchange may facilitate an offering of a new round of securities (we sometimes call this a funding event) to raise capital. The distribution of the listed round of securities could be by an offering that is either private or public, depending on the circumstances.

2. The projects can come from any project originator 18, including, for example, academic laboratories and biotechnology or pharmaceutical companies. Projects that otherwise might remain unfunded can more easily attract funding, thus increasing the likelihood, for example, of finding cures for diseases.

3. A market-based mechanism is provided by the exchange for investors 20 to value projects using, for example, credible, timely, objective information 22 (which may or may not be public) supplied by the project or by experts or by other parties. This increases the likelihood that investors will be able to invest in projects of the highest quality and probability of success.

4. Because the exchange provides some liquidity for project-associated securities, a broader range of investors can be attracted, especially to earlier stage projects, in addition to traditional venture capital and pharmaceutical company investors.

As shown in FIG. 2, the projects that are executed during an example product period can include, for example, a “conception project” 40 (which may not require outside funding) in which a project originator, or some other party, develops a hypothesis about a biochemical mechanism associated with a disease. This may be followed by a second project 42 that includes selecting and validating a molecular target or a pathway whose modulation (stimulation or inhibition) can either prevent or slow down the disease.

In a third project 44, a set of in vitro and in vivo assays may be created to allow for screening of either small molecules or biologics (e.g., antibodies, peptides, proteins, or various types of RNAs) for desired activity. A fourth project 46 could include high-throughput screening of large proprietary or commercially available compound collections to find lead compounds. In an alternative or parallel project, potential drug candidates can be designed rationally (using, for example, structure based drug design, fragment screening, engineered proteins, or siRNAs).

Structures of lead compounds, whether small molecules or biologics, are optimized, in a fifth project 48, to achieve required efficacy, bioavailability, stability, safety, and other physical or pharmacological properties. By the end of these preclinical experiments, the lead compound becomes a clinical candidate that typically undergoes three stages of clinical trials, each of which may be considered a project.

The first clinical trial stage (project 50) tests safety and tolerability of a candidate. The second clinical trial stage (project 52) determines a required therapeutic dose and tests the candidate for efficacy. The third clinical trial stage (project 54) definitively assesses how effective the candidate is, in comparison with a current ‘gold standard’ treatment.

If all three clinical trial stages are successfully completed and (in the United States) the FDA approves 55, the clinical candidate becomes a drug and can be commercialized 56 and prescribed to patients.

Each of the projects during the product period (and each of the stages for each project) carries a cost 60 to execute. The cost of performing each project and each stage of each project tends to be higher than the cost of each of the prior projects or stages. At the end of each project or stage, if the project or stage is successful, the project will have contributed to a corresponding product value 341 that is higher than the product value at the end of the prior project or stage.

At the end of the project that is completed just prior to commercialization, the product value can approximate the total present value of the profit stream that can be generated by the commercialization of the product. That is, each project and stage is intended to, and if it is successful does, enhance the expected potential commercial value of the target product. That commercial value, which we call the product value, can be estimated at the end of each project or stage and reported in the project information. Investors can make decisions about the current market value 30 of project securities based on the current product value.

In some examples, a project could be aimed more broadly at developing a platform technology from which the target product and other products can be generated. The impact of the completion of the platform development project on the product value may be hard to predict; a platform that offers a clear path to the product within a short period of time may be more attractive to the investors. Platform technology projects are typically riskier and require significant investments even before any specific drug candidate can be identified; on the other hand, platforms can be more lucrative for investors in the long term because a successful platform has a potential of generating multiple products.

Each project can be done in stages each of which can end at a milestone 66. The stages of a project can be done sequentially or in parallel or both. Funding can be directed to an entire project or only to a stage or stages of the project. Each project in turn has target deliverables 36 (FIG. 1).

Several examples illustrate the wide variety of kinds of projects, stages, and entities that can be the subject of funding.

In the case of small molecule drug discovery and development, discovery or publication of a promising target or pathway or new insights about known targets often triggers a race to find a modulator of the target or pathway that has drug-like properties. Any project originator 18 that can set up appropriate assays and has access to a compound collection and to medicinal chemistry resources can be a competitor in the race. The project originator can form the entity 32 that is to issue the project securities and arrange the listing of the project on the exchange to be funded (we sometimes refer to the entity as a project entity). Alternatively, contract research organizations (CROs 131) can provide essentially any chemistry or biology support that the drug discovery project might need. Such resources may enable a DDD project to be run almost entirely in a virtual manner, that is with the actual work being done by CROs and managed by the project originator.

Technologies for discovery and development of monoclonal antibodies (mAb) as therapeutics are widely accessible, and biotechnology companies and CROs provide services such as design of antigens, immunization, screening, hybridoma cell line production and optimization, cloning, expression, and humanization. Each of these activities can represent a project or a stage of a project to be funded. Other types of biologics include peptides, engineered recombinant proteins (other than mAbs), siRNAs, miRNA, vaccines, gene-therapy and cell therapy. In some examples, the CROs can be or form the project entities that are to issue the project securities even though other projects in the product timeline may be done and funded by other entities.

A broad range of entities can be potential originators of projects and can be or form the project entities that issue the project securities.

For example, government-funded academic laboratories are a source of new target products and biological knowledge associated with them. For purposes of listing a project with the exchange based on the work of such a laboratory, the project entity (such as a corporation or partnership) would be formed outside of the academic entity, to own the intellectual property 134 (IP) that is developed by the laboratory and then licensed to the new project entity. In this scenario the academic or other institution that forms the project entity, assigns the IP to it, and receives a license in return may be thought of as the project originator.

Biotechnology or pharmaceutical companies that often have limited resources constraining their ability to fund all DDD projects that deserve funding could be the originators of some of those projects. Financing projects through the exchange would allow biotechnology and pharmaceutical companies to conduct additional projects and stages while sharing the risk with outside investors. In each case, a new separate project entity could be established to hold the IP and issue the project securities. The license agreement between the new separate entity and the project originator could assure the project originator a first (or exclusive right) to use and commercialize the results of the project or its stages.

Project originators 18 include business entities created for the sole purpose of owning project assets, including IP, and running projects or stages. The entities could be created by academic founders or could be spun out of a biotechnology or pharmaceutical company (similarly to stock and warrant off-balance sheet research & development, SWORD, funding, for example). Alternatively, companies specializing in running multiple DDD projects or stages could be created; each new project and stage would be initiated by issuing a separate round (series) of project securities.

We use the term intellectual property (IP) to refer, for example, to the information, data, knowledge, know-how, software, and other intellectual product of the work that is performed in a project or stage of a project, and also any formal assets that encompass the intellectual products, especially trade secrets, copyrights, patent applications, and patents. The project securities are typically issued by the project entity that owns or has rights in the IP that is owned, controlled, or produced during the project or a stage of it that is being funded.

The project securities can be in the form of equity securities of the issuing project entity or other kinds of securities that represent or have a call on the IP and other assets at some time, such as liquidation of the entity or termination of the project or stage. The assets on which the project securities have call could be not only IP assets but also hard assets such as laboratory equipment, samples, molecules, and other items that are used in the project. The current market value of the project securities could represent liquidation of the assets (in a worst case) or the current product value, which may be enhanced by the project or stage. Because the project securities represent a call on the IP assets, and because the product value has a direct correlation to the ability of the IP to provide a clear commercialization path for the product, the current market value of the project securities ought to be correlated to the current product value. Thus, even after a project or stage has been completed, the project securities will continue to have value associated with the product value and therefore can be traded on the exchange.

Each round of securities is used to raise capital to fund a specific stage or stages or an entire project that has as its ultimate goal the commercialization of a product or products, following, for example, FDA approval. When the funds are being raised for a stage or group of stages, the goal is to achieve the target result (we sometimes call it a deliverable) that is defined for the end of each stage of the project. A deliverable could be a successful clinical trial, for example.

Other features of the project securities will be designed to assure that investors are comfortable with and find it easy to buy and sell the securities on the exchange.

In some implementations, a project director would be appointed by the project entity to lead the project management and to manage all aspects of the project. A board of directors or equivalent body could be established to represent the interests of the project and the holders of the securities. We sometimes refer to the project director and his group as the project management, and the board can sometimes be considered part of the project management. The project management can include key scientists responsible for executing tasks in the project, for example, a head chemist or head biologist or a clinical head. Members of the project management can vary with the stage of the project and on how much work is outsourced.

In some examples, each project or stage can be operated using either internal scientific resources and infrastructure of the biotechnology or pharmaceutical companies that are the project originators (subject to the rules of the exchange related to listing and reporting), or outside service providers such as CROs 131.

During execution of a project, the project director and other management are responsible for all operational and strategic aspects of the project, including adjustments of the research plan if necessary, and for complete, accurate, and timely reporting. The project management also manages the project budget and generates accounting reports as a part of periodic project review. The exchange monitors the timeliness, completeness, and integrity of the reporting to ensure that the project remains eligible for listing and trading on the exchange. If the project (or stage or stages) that was funded runs out of money before reaching the project deliverables, it is not (for that reason, at least) de-listed from the exchange and can attempt to raise additional money to complete the deliverables by using the same fund raising mechanism. If this attempt fails, the project is de-listed from exchange.

With respect to reaching milestones during project execution or target deliverables at the end of the project, although the target deliverables and milestones are defined at the outset of the project, often a subjective judgment is made then because the scientific process is unpredictable. The exchange makes a final judgment whether a project substantially reached the target deliverables defined in the research plan, with input from the project management and expert opinions. If the project reached the target deliverables, it is eligible to enter a new round of funding in which goals are set for the next stage, money is raised, and execution is undertaken.

In regulating the issuance and trading of project securities, the exchange provides a mechanism for listing 38 a project on the exchange and for listing each round of project securities of the project. The listing process ensures that the project and the project securities meet defined listing criteria. A project or project securities listing lasts for a period starting with the formal listing and ending with a de-listing. The listing period may extend beyond the termination of a project or portion of the project to permit continued trading of the project securities after the project or stage or stages have been completed.

As shown in FIG. 3, when each stage or group of stages or an entire project is to be funded on the exchange and then completed, a sequence 60 of project steps is followed. Before listing can be achieved, the project originator must define 120 the project (or stage or stages) including its overall goal, a plan for reaching the goal, and a sound scientific and business rationale that justifies a prediction that the goal can be reached.

The result (of this step and other steps that follow it, see below) is a research plan (or other project plan) that also describes the IP associated with the project, the freedom to operate associated with the project (step 122), and the scientific skills and equipment required to achieve the project deliverables. The research plan and a detailed budget (step 125) articulate the work to be performed to achieve the deliverable at the end of the project (or stage) with a reasonable likelihood of success.

Project management is selected in step 124. Each task to be performed is associated with one or more members of the project management. The project management could include, for example, scientists or teams of scientists and service providers who can execute the tasks as identified by a project director and other members of the project management. The project management identifies qualified project participants who can be enlisted on favorable financial terms. When appropriate, multiple potential contributors are evaluated (for example, by issuing requests for proposals, RFPs, or through other bidding mechanisms) to select the ones best suited to the project. The research plan identifies the project management and the individual and corporate participants of the project who will be contributing to its execution and are important to its success. These could include named scientists in a biotechnology company that formed the project entity (we sometimes also refer to the party that has been created for or devoted to the project and will receive the funding as the funded entity) or in CROs.

The freedom to operate review (FTO) 122 determines whether the product that is the final goal of the project and its stages can be commercialized without infringing the IP it does not have rights to. The FTO analysis is produced by IP attorneys.

A budget is defined 125 that is based on negotiated terms with all projects participants, as well as on infrastructure and equipment requirements of the project, by the project management. The budget is a detailed itemization of money needed to execute all project or project stage tasks to achieve its deliverables or milestones. The budget lists in considerable detail all of the expenses that are expected to be incurred to support all activities needed to reach the target result at the end of the funded project (or a funded stage or stages). Considering uncertainty and unpredictability inherent in the project (e.g., scientific research), an extra amount of money, for example, 20%, could be included in the budget to cover unanticipated plan changes and expenditures.

In another step, expert reports 127 are generated. Expert reports can be produced both prior to the listing and distribution of securities and afterwards for the benefit of investors and other parties.

Providing investors, who are typically not scientists, with a complete, accurate and fair assessment of the project progress by a credible expert enables investors to value the project and the product, both at the time of fundraising and during the trading period. It is the responsibility of the exchange to ensure that expert reviews are credible and timely. In preparation for project funding, the experts prepare reports and the exchange reviews them and either accepts them or insists on further work.

The experts 26 who prepare the reports (both before listing and during project performance) may be traditional investors in projects of the type being funded. These experts could be of the kind used, for example, by venture capitalists or investment bankers in areas of science or in a specific disease, to value companies and make investment decisions.

For early stage projects, the experts may include, for example, academic opinion leaders in a relevant area of science. Former pharmaceutical scientists and executives may be instrumental in evaluating projects with preclinical and clinical drug candidates, and clinicians can become involved as projects approach clinical trials stage. Experts who provide opinions and reports are hired by the exchange and cannot own equity in projects they review.

The expert reports can cover a wide variety of matters related to project value or product value, including the strength of the project's intellectual property (IP), interpretation of chemical, biological and pharmacological data, the competitive landscape and market potential, and challenges yet to be solved by the project, scientific and business rationale of the project, the freedom to operate with respect to intellectual property of other parties, the project team credentials, and the practicality of executing the research plan. The expert may or may not be an employee of the exchange.

The information that is provided to investors and other parties (which we sometimes call reported project information or simply project information) may include a very broad range and depth of information. The information may be provided from time to time and at many times, including before initiation, during execution, or after completion of a project or the commercialization of a product, that is, during the project period or during the product period. The information can be provided during the distribution period and during the trading period for one or more rounds of the securities.

Publicly disclosed information need not disclose critical IP that defines a competitive advantage of a project (for example, details of biological assays, or chemical structures of lead compounds). Such critical information could be made available to experts under confidential disclosure agreements, but not disclosed in an opinion or report of the expert. Certain non-enabling characteristics can be described, however, for example, the type of assay (binding, reporter, or high-throughput, for example) or physical and pharmacological properties of a lead or candidate compounds (for example, molecular weight, log P, the number of hydrogen bond donors/acceptors, oral absorption, clearance, metabolic stability).

The project information could include the research plan, milestones, and a sound business rationale for predicting that the product value will increase as the milestones are reached. Progress on projects, risks, and properties of a target product could be reported. In connection with the distribution or trading of project securities, the project information may be necessary or useful for the exchange, experts, or investors to determine an accurate value of the project or a product or the related securities at a given time.

The project information can include regular reports by project management that are used by investors in making investment decisions. The exchange ensures that only high quality and credible information is contained in these updates. Depending on the stage of a project and the rate of change of activity on the project, the frequency of updates may be adjusted based on reporting rules 41 of the exchange.

The project information can be limited to information about a project or a stage of a project or can extend to the product with which the project is associated.

During the trading period after initial distribution of project securities, reports that are part of the project information can include project status reports generated by project management, expert reports on project progress, and expert accounting updates with respect to the detailed budget.

The range of parties to whom portions or all of the project information is disclosed can vary from the broad public, to only investors interested in the project, to only a small number of experts 26 who have a need to know and are authorized to receive it.

In other steps shown in FIG. 3, the terms of sale of the securities are analyzed 126 and the listing process with the exchange is conducted, including preparation of a prospectus, and iterations of those steps 80, 87.

The project prospectus provides potential investors with material information about the securities being offered by the project. It includes the detailed due-diligence report, a research plan with the detailed budget, and the securities purchase term sheet. The prospectus can contain a wide variety of information useful for the exchange, investors, and experts.

The term sheet describes the legal and business structure of the securities to be offered and the terms of a purchase agreement for the securities.

The structure of a round of securities may be conventional, although specific details can vary depending on the type of the project, its objectives, and its degree of progress toward a commercialized product. Once the prospectus has been accepted, the securities are formally listed 87 for offering on the exchange. Project securities can be issued in a single round for a project or in multiple rounds. A round of project securities can be issued to fund an entire project or a portion of the project.

The exchange ensures, for example, that for each of the listed projects a sound scientific and business rationale is presented, that users of the results of the project will have reasonable freedom to operate with respect to the IP of others, and that the project is run by a qualified scientific team.

In some examples, the project securities of a new round are distributed by the mechanism of, in some implementations, a uniform-price (each winning bidder pays the same price) auction 88 in which the objective is to raise a targeted amount of money while maximizing the value of each security sold.

Other types of known or new auction algorithms, open or sealed, can be used. For example, a fixed number of securities and a range of potential prices can be offered to investors, with all winning bidders paying the amount of the highest non-winning bid. This algorithm is similar to the model used to auction United States treasury bills, notes and bonds, and in the OpenIPO model operated by W.R. Hambrecht & Co. Alternatively, a target amount of money to be raised can be fixed, and the minimum number of securities necessary to reach the target are sold to a group of highest bidders (again, all winning bidders paying the amount of the highest non-winning bid) thus reducing dilution of the project equity.

Parties who can be provided with equal open access to bid at the auction can include any qualified individual or institutional investor, and entities, such as biotechnology and pharmaceutical companies. The auction mechanism ensures that securities are allocated in an impartial way, with no preferential allocation to any investor.

Prior to auction of a new round of project securities, an initial valuation 130 must be set for the project or stage or stages for which the securities are being offered. For a new project, project valuation is done by the project management 29 based on comparative data for similar projects and products at similar stages, adjusting the value as necessary by a variety of relevant factors such as the competitive situation and risks unique to the project.

After the initial value is set and the online auction is conducted, the sales are tested 89 against the minimal acceptable level of funding that was described and justified in a prospectus and disclosed to the investors bidding for project securities. If the minimum level is reached, the fundraising is considered successful, and the offering proceeds to completion, funds received in the auction are paid to the project entity 32, and the project is executed 90.

The project valuation or product valuation at different times during the work on a project (or a stage or stages) is affected not only by the progress of the project itself, but also by external factors.

For example, the values of different projects that have been active for the same amount of time vary for different therapeutic areas. General biotechnology and pharmaceutical market conditions and the level of competition in a particular disease mechanism are also important factors in project valuation.

For projects that are in the trading period (following initial distribution), the value of a project is set by trading. However, if additional funds are raised in an offering of another round of funding, after successful achievement of target deliverables in a previous project stage or previous project associated with the product, the project value may be adjusted based on comparative data and other factors similarly to the valuation of a new project.

During the trading period, the current market price 30 at which project securities are traded may be affected by the perceived project value, the perceived product value, project information 22, periodic published reviews of third parties, and published or private analysis of the reported project information and other data.

The trading period may not be continuous. Rather trading may be open during a time window after each update of the project information 22 is published and closed during other periods. By setting the length of the trading window to be longer than the time between updates, the trading can be done continuously.

Even if a project satisfies the exchange listing criteria, of course, the project or a given stage of it or any of the milestones within any stage may not be completed successfully, and the target product may never become an FDA approved drug.

For each succeeding round of securities, a minimum amount of funding necessary for the project to be able to continue effectively is determined and approved by the exchange as part of the listing of the round. If the offering fails to raise this minimum amount, the project is de-listed 93. After de-listing, the project management can adjust 91 its research plan, milestones, budget, valuation, participants, and other factors and resubmit the project for listing on the exchange again.

Once listed, the project or project securities may be delisted in different ways. For example, de-listing can occur as a result of a decision by holders of a majority of securities who have decided they wish to run the funded project or stage or stages as a proprietary venture closed to the public. For this purpose, as a project matures, an investor (for example a biotechnology or pharmaceutical company) could seek exclusive control of a project by acquiring a majority control of the equity securities.

In another example, listed projects and project securities also may be de-listed if the project fails during the project period and its execution stops.

Thus, the outcome for an investment by an investor will depend on the success of the project that is tied to the project securities. If the project fails, the project value and perhaps the product value will fall to zero, and the investment will be a loss. If the project succeeds, the IP and perhaps other assets held and developed by the project will imply a significant value of the project. The increase in value may drive increases in the price of the project securities when traded and the investor's share may appreciate considerably. In some cases, a buyout or other liquidation event may occur that would entail a payback of money to the investor representing an increase or decrease in his investment depending on the success of the project and the circumstances of the buyout or liquidation event.

As shown in FIG. 4, the operations, functions, and facilities required to establish and maintain the exchange, accept and process listing applications and maintain listings, distribute project information relevant to each project, stage, and milestone, facilitate the auction or other distribution and trading of project securities, and interact with investors, experts, project originators, regulatory authorities, and other parties are provided by a hardware, software, and network infrastructure 70 that includes an exchange informatics engine 72 which can be hosted and maintained by the exchange or by a third party on behalf of the exchange.

The engine can take a wide variety of forms and specific implementations including one or more computers running operating systems and software to provide the features described here and other features. The computers can be distributed or located centrally. The engine 72 hosts databases 76 and related database managers that hold and provide access to a wide variety of information useful or necessary to operate the exchange. In addition a set of software applications 79 provide needed and useful features. The computers can operate in a client-server, peer-to-peer, or other mode. Interaction with other parties can be through local area, wide area, or other networks 78, including the Internet, or by dial up or trunk communication lines, or in any other of a wide variety of communication modes.

Through World Wide Web or other technology, the project originators 12, project entities 32, CROs 131, project management 29, the exchange managers, experts 26, investors 20, and other parties, have access through the networks or other communication channels to the applications 79 and the information in the databases 76 for the purpose of retrieving information or providing information to be stored and a wide variety of other purposes. Each of the participating parties can use wired or wireless or handheld devices to communicate with the system. The interaction can occur through one or more user interfaces (described later) hosted by the engine and accessible anywhere using a web browser.

The databases 76 store participant information 701 about participants, including profile information, account information, and other data associated with each of the project originators, project entities, CROs, project management, the exchange managers, experts, investors, and others. Each project or stage or stages that is or will be the subject of funding is tracked by project or product information 703, stored in the databases. The project information includes the project plan, budget, staffing, financial performance, milestones, deliverables, completion history, status, deliverables, expert reports, terms of sale, prospectus, freedom to operate data, funding history, auction data, trading, price history, valuations, participants, and any other information necessary or useful to the funding, monitoring, and performance of any of the projects and the products. The opinions and reports of experts 715 are maintained in the exchange databases and access to them during their drafting and later, once they have been completed and approved, is provided by the exchange through online facilities to the experts, the investors, the exchange managers, and others.

The exchange also stores exchange information 704 in the databases as needed or useful in managing its operations. The exchange information includes listings, listing procedures, auctions, auction procedures, reports, reporting rules, trading information, and a wide variety of other data. In the databases, the exchange also maintains and makes accessible a list of prescreened and rated experts, vendors, service providers, and CROs to ensure that investors can assess projects to determine those in which the contributors are of high quality.

A wide variety of applications 79 runs on the engine. Some or all of the applications interact with other participants through the network and with the databases hosted by the exchange as needed.

Distribution and trading applications 708 provide for online operation of an auction system and a trading system for project securities. A communication application 709 manages the secure transmission and receipt of information to be held in the databases and to be used for all of the functions of the system. The process of listing and delisting projects and securities is managed interactively online by a listing application 710. Secure interaction with experts to provide information (including confidential information) to them and to receive their reports and opinions is managed by an expert system 711. A content distribution application 712 provides feeds of information about auctions, trading, and the projects and project securities listed on the exchange for use and distribution by online and other publishers.

A project dashboard application 713 provides top-level easy-to-use information about funded projects and their progress for use by experts, investors, project management and personnel, and exchange managers, for example. The information on the dashboard is kept current and continuously updated to provide investors with up-to-date statistics collected across biotechnology and pharmaceutical industries that reflect value-setting events, for example, the values of licensing deals in various therapeutic areas and for various types of products.

FIGS. 5 through 8 illustrate features of user interfaces.

As shown in FIG. 5, a project information interface 150 provides investors with access to up-to-date information about a project of interest. A user can navigate to this page from another page (not shown) that enables the user to search for and locate the project of interest based on a variety of search criteria. A Project name/Logo area 152 identifies the project for the user. A button 154 in this area opens up a Project Dashboard interface (described later) that summarizes important data about the progress of the project. The current price area 155 shows the security price used in the last executed transaction (auction or trade) of project securities. When there is more than one round of project securities for a project, the user is enabled to navigate to the current price for any round of interest.

A Project background area 156 summarizes 158 a scientific and business rationale of the project, and includes a link 160 to a more detailed information page. A Project team area 162 informs investors about management and scientific teams executing the project and critical service providers (for example, CROs) carrying out parts of project work. Links 164 to more detail about these parties is provided. A button 166 in this area opens up an addressed email message to request an exchange representative's call or to ask a question.

A Project News area 168 displays headlines of news about the project that has been provided by the project team. The area includes links 170 to more detailed information. A Competition News area 172 displays headlines and includes links to news items about competitors' activities on the same target or same disease indication. A Current Project update area 176 contains links 178 to the latest progress reports, expert reviews, IP updates, and budget updates issued periodically by the project management. A Past Project updates area 180 provides links 182 to archived past project updates.

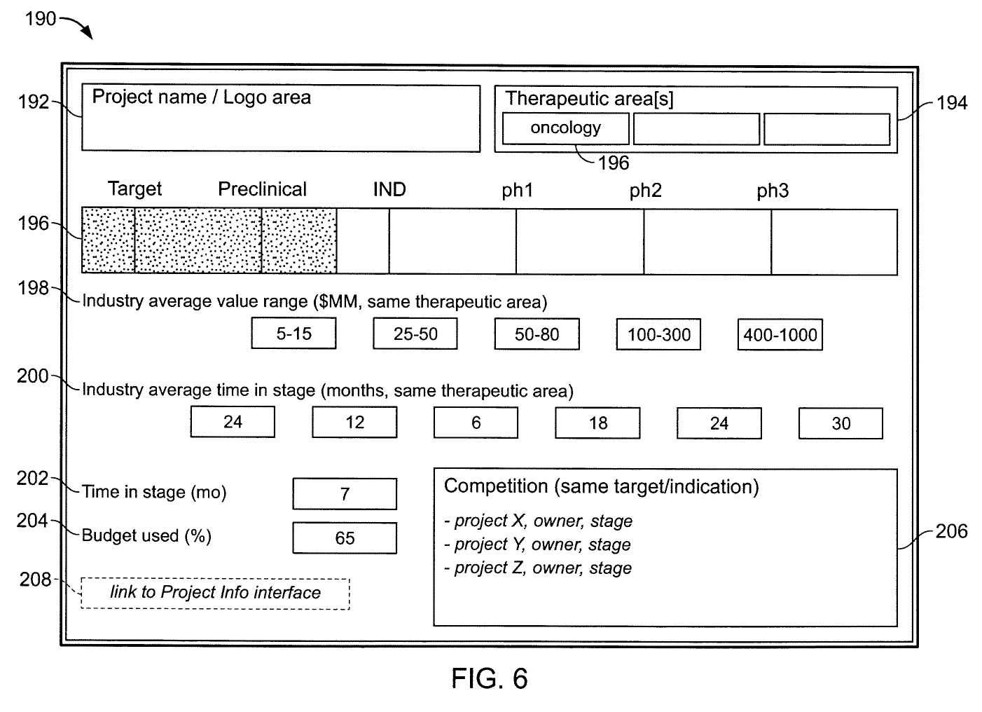

As shown in FIG. 6, a Project Value Dashboard 190 provides important information for investors to make an educated estimate of current project value. In an area 192, a specific project and one or several therapeutic areas it addresses is identified. A progress bar 196 shows how far the project has advanced within an overall drug discovery and development process. Also provided are continuously updated value ranges 198 of projects in the same therapeutic area averaged across biotechnology and pharmaceutical projects, derived from information about recent licensing deals. The time in stage 202 for the project can be compared to current industry averages 200 for the time spent in a given project stage. A continuously updated budget usage number 204 provides a snapshot of project financial health and its ability to successfully reach the next milestone. In the Competition area 206, a list of known competitive projects (same target and/or disease indication) is listed. Links to information about them can also be provided. A button on the bottom opens the Project Information interface (FIG. 5) providing in-depth information about the project.

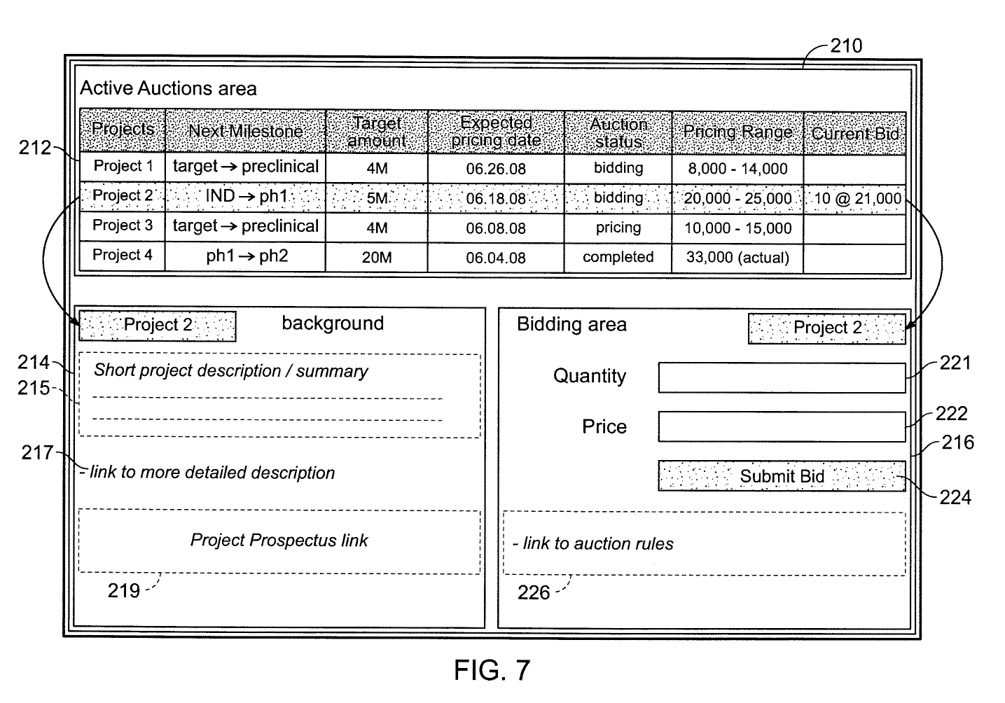

As shown in FIG. 7, an Online auction interface 210 facilitates an investor's participation in a fundraising event for projects conducted by online auction. An Active Auctions area 212 lists the latest auctions that are in progress or recently completed. Each row in the table represents one project and shows a milestone (for example) that the project aims to achieve using the money raised, the amount being raised, the expected date on which the project security price will be set based on the results of the bidding process, the current status of the auction, and the expected pricing range. The Active Auctions area is linked to the Project background and Bidding areas 214, 216, so that when the user selects (highlights) a given project, the Project Background area displays information 215 about the project and provides a link 217, 219 to a Project Prospectus. At the same time, in the Bidding Area, the investor can submit a bid indicating how many securities 221 and at what price 222 the investor is willing to buy. If this particular investor already placed a bid, it is indicated in the Project line in the Active Auctions area. A link 226 is also provided that enables the user to consult details about the auction rules. A submit bid button 224 enables the user to commit to the transaction.

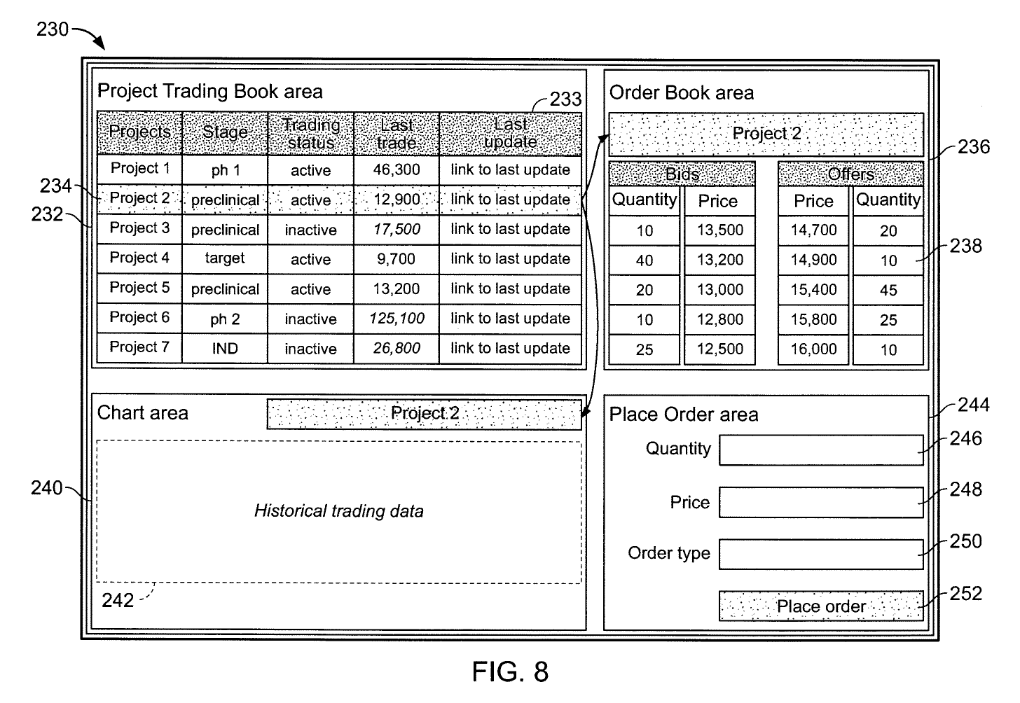

As shown in FIG. 8, an online Trading interface 230 facilitates online trading of project securities during project execution after fundraising events. A Project Trading Book area 233 lists all projects for which project securities can be traded. The line 234 for each project indicates the stage of the Project, the trading status (active during designated trading periods, or inactive), the security price used in the last recorded transaction, and a link to the latest project update. The Project Trading Book area is linked to all other areas on this interface, so that selecting (highlighting) a particular project line displays relevant information about this project in all other areas. The Order Book area 236 lists current bids and offers 238 currently submitted for this project. The Place Order area 244 allows an investor to place either buy or sell orders for project securities by indicating a quantity 246, a price 248, and an order type 250, and using the place order button 252 to commit to the transaction. The Chart area 240 includes a diagram of historical trading data indicating how project securities price changed over time.

Other interfaces could also be provided. A portal page or site could be offered to enable a user to (among other things) log in, select one or more projects and one or more rounds of securities for a project, and navigate to one or more of the interfaces including those shown in FIGS. 5 through 8.

In addition to the prospectus, expert reports and opinions, exchange-sanctioned reports by the project and other exchange supervised information, an open forum or blog can be hosted by the exchange or other parties to enable opinions about projects to expressed by anybody.

Other implementations and applications are within the scope of the following claims.

For example, in the description above, the manner of distribution of the project securities can be done in a way that is intended to comply with the securities laws of the United States. In some implementations, a group or network of accredited investors is created, and they confirm their status as accredited investor. The group could include individuals, venture capital firms, foundations, and biotechnology and pharmaceutical companies. Investors in the group are then informed about offerings of project securities, all are provided with the same information, and all can participate in the offering through online auction. All material information about the project is made available to all investors in this group on a regular basis. Investors of the group can sell the securities they purchased to other investors in the same group who may or may not already own the securities of the same project.

A wide variety of other distribution techniques may also be used provided they are lawful in the jurisdiction in which they are used. The securities laws of different countries differ and they change over time, so the particular techniques that are useful may change and may differ depending on the location of the distribution.

For example, it may not be necessary to limit the offering to accredited investors. And general solicitation of buyers may be permissible. The concept discussed here is meant to span any permissible mode of distribution of the project securities.

1. A computer-based method comprising
providing an online exchange facility that runs software applications and exposes an online interface to users to
(a) enable a project entity to fund a project by online selling, to investors, of securities that represent interests in the project, and
(b) enable investors to trade the securities online at prices that are determined by market forces and are related to progress of the project in reaching a deliverable that has been defined for the project prior to the funding.

2. The method of claim 1 in which the online interface also provides online access to information that reports progress of the project in reaching the deliverable.

3. The method of claim 1 in which the deliverable is associated with potentially greater value of a product that depends on the reaching of the deliverable.

4. The method of claim 3 in which the product comprises a drug.

5. The method of claim 1 in which the online interface also enables experts to receive information about the project online and provide expert reports about the project online for use by investors.

6. The method of claim 1 in which the online interface also enables parties engaged in executing the project to report progress in reaching the deliverable.

7. The method of claim 1 in which the online interface also enables a project originator to list the project or the securities on the online exchange facility in accordance with listing rules.

8. The method of claim 1 in which the online interface enables the project entity to fund the project by conducting an online auction.

9. The method of claim 1 in which the online interface is exposed through the World Wide Web.

10. The method of claim 1 in which the online interface reports progress of a project against expected milestones and against progress of the project based on progress of comparable projects.

11. The method of claim 7 in which listing the project depends on a determination whether the project meets quality criteria.

12. The method of claim 1 in which the online interface also enables development of a valuation of the project based on information about progress in achieving the deliverable and on external market data.

13. The method of claim 2 in which the information is provided online on a project dashboard.

14. The method of claim 1 in which successive projects or stages of projects are funded by distribution of successive rounds of securities that represent interests in the project.

15. The method of claim 1 in which the securities have a call on intellectual property created by the project.

16. A computer-based method comprising
providing an online exchange facility that runs software applications and exposes an online interface to users to
(a) enable a project entity to fund a drug discovery and development project by online selling to investors securities that represent interests in the project entity, and
(b) enabling investors to trade the securities online at prices that are determined by market forces and are related to progress of the project in developing intellectual property related to the drug.

17. A medium bearing instructions to cause a device to:
provide an online exchange facility that runs software applications and exposes an online interface to users to
(a) enable a project entity to fund a project by online selling, to investors, of securities that represent interests in the project to investors, and
(b) enable investors to trade the securities online at prices that are determined by market forces and are related to progress of the project in reaching a deliverable that has been defined for the project prior to the funding.

18. An publicly accessible online interface that enables a project entity to fund a project by online selling, to investors, of securities that represent interests in the project to investors, and enables investors to trade the securities online at prices that are determined by market forces and are related to progress of the project in reaching a deliverable that has been defined for the project prior to the funding.
